(19) United States
(12) Patent Application Publication
(10) Pub. No.: US 2026/0094001 A1
(43) Pub. Date: Apr. 2, 2026

(54) TRANSFER LEARNING FOR ARTIFICIAL INTELLIGENCE (AI) AND MACHINE LEARNING (ML)-BASED BEAM MANAGEMENT

(71) Applicant: VIAVI SOLUTIONS INC., Chandler, AZ (US)

(72) Inventors: Yun CHEN, Stevenage (GB); Onur Dizdar, London (GB); Fehmi Emre Kadan, London (GB); Stephen Wang, Stevenage (GB)

(73) Assignee: VIAVI SOLUTIONS INC., Chandler, AZ (US)

(21) Appl. No.: 18/904,464

(22) Filed: Oct. 2, 2024

(51) Int. Cl. G06N 3/096

(52) U.S. Cl. CPC G06N 3/096

(57) ABSTRACT

Transfer learning (TL)-based systems, methods, and devices are provided for beam management in communication networks. In one aspect, a system may implement a transfer learning (TL)-based method comprising generating a neural network model for beam management in a telecommunications system, designating a plurality of labels, wherein one of the plurality of labels is associated with measurements from beams associated with a first set of measurements for a first frequency (f₁). The system may also train the neural network model for the first frequency to produce a trained neural network model, including inputting measurements from beams associated with a second set of measurements for the first frequency (f₁) and implement the trained neural network model to output a probability of each beam in the first set of measurements for the second frequency (f₂) is a Top-1 beam, and determine beam identifiers (IDs) for the Top-K beams.

### TECHNICAL FIELD

This disclosure is generally directed to implementation of artificial intelligence (AI) and machine learning in telecommunication systems, and more specifically directed to utilizing artificial intelligence (AI) and machine learning (ML)-based transfer learning for beam management (BM).

### BACKGROUND

Artificial Intelligence (AI) and Machine Learning (ML) techniques are being increasingly adopted by a wide variety of industries. This includes the telecommunications industry, where the adoption of AI/ML may usher in a new era of improved system performance, higher efficiency, enhanced end user experience, etc. For example, existing Working Groups (WGs) within the 3^{rd} Generation Partnership Project (3GPP) are increasingly turning to applying AI/ML to many aspects in present and presently developing mobile network systems (e.g., 5G, 5GNR, 5G-Advanced, etc.), as well as future mobile network systems (e.g., 6G et seq.).

Regarding the radio air interface between a User Equipment (UE) and a network Base Station (BS), which may be, e.g., a Next Generation Node B (gNB or gNodeB), in a mobile telecommunication system, there may be many specific AI/ML use cases. Examples include Channel State Information (CSI) enhancement, beam management, positioning accuracy enhancements, Radio Resource Management (RRM) measurement prediction, measurement event prediction, and Radio Link Failure (RLF) prediction. Indeed, generally speaking, any systems, apparatuses, and/or methods which may apply specific AI/ML techniques and/or methodologies to management and operations of the air interface components of a telecommunications system may be beneficial.

### BRIEF DESCRIPTION OF DRAWINGS

Features of the present disclosure are illustrated by way of example and not limited in the following figure(s), in which like numerals indicate like elements, in which:

FIG. 1 is a block diagram illustrating a conventional mobile telecommunications transmitter/receiver system, according to examples of the present disclosure.

FIGS. 2A-2C are block diagrams illustrating neural net receivers and, in some cases, neural net transmitters in various configurations, according to examples of the present disclosure.

FIG. 3 illustrates a diagram of an implementation structure for a neural net implementing artificial intelligence (AI) and machine learning (ML), according to examples of the present disclosure.

FIG. 4 illustrates a model framework of AI/ML-based BM in a plurality of cases, according to examples of the present disclosure.

FIGS. 5A-5C illustrate various aspects of an implementation of AI/ML-based BM techniques, according to examples of the present disclosure.

FIGS. 6A-6B illustrate aspects of a neural network architecture that may be utilized for training and testing for BM, according to examples of the present disclosure.

FIG. 7 illustrates a transmitter uniform linear array (ULA) of N antenna items, according to examples of the present disclosure.

FIG. 8 illustrates an antenna array at a second frequency (f₂) that may have a same number of antenna items and a same antenna-spacing/wavelength ratio as an antenna array at a first frequency (f₁), according to examples of the present disclosure.

FIG. 9 illustrates aspects of a neural net architecture implementing zero-shot model transfer learning from a first frequency (f₁) to a second frequency (f₂) without fine tuning, according to examples of the present disclosure.

FIG. 10 illustrates an antenna array setup for a second frequency (f₂) that may have a same number of antennas but may have a different antenna-spacing/wavelength ratio than an antenna array setup for a first frequency (f₁), according to examples of the present disclosure.

FIG. 11 illustrates an antenna array setup wherein an antenna array setup may have an M number of antennas, and an antenna array setup wherein an antenna array setup may have an N number of antennas, according to examples of the present disclosure.

FIG. 12 illustrates an antenna setup for a second frequency (f₂) having different numbers of antennas and different antennas-spacing/wavelength ratio than that for an antenna array setup for a first frequency (f₁), according to examples of the present disclosure.

FIG. 13 illustrates a neural network operation implementing data transfer learning where measurements for a second frequency (f₂) may be used as input for a neural network trained in a first frequency (f₁), according to examples of the present disclosure.

FIG. 14 illustrates aspects of data transfer learning techniques where measurements for a second frequency (f₂) may be used as input of neural network trained in a first frequency (f₁), and may be used to predict a beam ID for the first frequency (f₁), according to examples of the present disclosure.

FIGS. 15-16 illustrate charts depicting performance results of an AI base beam management algorithm for prediction accuracy for predicting the best beam ID at a second frequency (f₂) for a neural network trained in first frequency (f₁), according to examples of the present disclosure.

FIG. 17 illustrates a block diagram of a system environment, including a system, that may be implemented to use artificial intelligence (AI) techniques to utilize transfer learning (TL)-based method to implement beam management in telecommunications systems, according to an example.

FIG. 18 illustrate a method for utilizing artificial intelligence (AI) and machine learning (ML)-based transfer learning for beam management (BM), according to an example.

### DETAILED DESCRIPTION

For simplicity and illustrative purposes, the present disclosure is described by referring mainly to examples and embodiments thereof. In the following description, numerous specific details are set forth in order to provide a thorough understanding of the present disclosure. It will be readily apparent, however, that the present disclosure may be practiced without limitation to these specific details. In other instances, some methods and structures readily understood by one of ordinary skill in the art have not been described in detail so as not to unnecessarily obscure the present disclosure. As used herein, the terms “a” and “an” are intended to denote at least one of a particular element, the term “includes” means includes but not limited to, the term “including” means including but not limited to, and the term “based on”means based at least in part on.

As used herein, the terms “AI,” “ML,” “Artificial Intelligence,” and/or “Machine Learning,” and/or “AI/ML” may refer generally to methodologies, techniques, and/or technology that creates one or models by learning/training using a large dataset of input such that the one or more models may be used to infer/produce results/output based on new and/or real-time input (and the term “AI/ML”will be treated as a singular noun herein).

While AI/ML is being discussed generally for use in telecommunications systems/networks, specific deployments/implementations have yet to be standardized and/or adopted, including, for example, AI/ML implementations for the air interface components in a mobile telecommunications system, such as, for example, those defined by the 3GPP standards. Recently, the 3GPP standardized the New Radio (NR) release to enable deployment of 5G (and eventually, 6G) worldwide.

As part of the deployment of NR, smaller and smaller wavelength bands are being implemented to affect greater bandwidth and data rate capacities. For example, implementation of 6G will likely require implementation of multiple frequency bands, including the current sub-six (6) GHz along with higher wave bands (e.g., the centimeter wave (cmWave) band). Typically, connectivity in lower frequency bands may be more robust than that in higher frequency bands. However, transmission of these high-bandwidth signals may come with significant attenuation and latencies.

To deal with these disadvantages, highly-directed (or “directional”) transmissions may be required to compensate for losses during propagation loss and to ensure acceptable communication quality. Furthermore, to achieve this needed highly-directional transmission, it may be necessary to provide precise alignment of transmission of beams. This precise aligning of beams for transmission may be referred to as “beam management (BM).” Traditional downlink BM procedure consists of three stages, including initial beam pair establishment, transmit beam refinement, and receive beam refinement. BM is one of the key features in NR to support static beamforming without the requirement of dynamic Channel State Information (CSI) estimation. Indeed, it may be said that BM is and will continue to be a crucial aspect of present and future communication networks.

However, it may not always be possible to gather and transmit measurement information that may be sufficient to identify proper BM/beam transmission characteristics. For example, this may often be the case in situations where user equipment (UE) may be mobile, or in situations where high(er) data rates may be necessary. Therefore, it may be appreciated that use of burgeoning AI and ML techniques in BM implementation may be beneficial.

As discussed further below, AI and ML techniques may be implemented to, among other things, provide greater efficiencies, improve prediction accuracy, and overcome previously-faced latency and bottlenecks associated with BM. Specifically, as discussed further below, AI and ML techniques may address increasing complexities associated with BM by, among other things, implementing learnings from gathered data and implementing techniques to address variations in implementation scenarios. As a result, various performance and efficiency optimizations associated with communications networks generally, and BM implementations specifically, may be realized.

Systems and methods described herein, among other things, implement transfer learning techniques based on AI/ML to perform BM in multi-antenna wireless networks. In particular, in implementing AI/ML-based BM, the systems and methods described herein may utilize neural networks trained to conduct spatial and temporal domain prediction to predict various aspects and measurements (e.g., Layer 1 Reference Signal Receive Power (L1-RSRP)) of beams. The AI/ML-based BM techniques described herein may be deployed at both UE side and network side (e.g., a BS, a gNB or gNodeB, etc.).

Furthermore, the systems and methods described herein may provide AI/ML model transferring from one frequency to another for improved efficiencies in, among other things, time of service and energy use. As used herein, this “transfer,” “transferring,” and “transfer learning” may include, among other things, information associated with (for example) frequency transferring, neural network model transferring, and data transferring. Examples of this information may include, but is not limited to, CSI, power delay profile (PDP), angle-delay attributes, etc.

It may be appreciated that data associated with lower wave bands may be more readily available and substantial that data associated with higher wave bands. For example, it may be easier to obtain measurements (e.g., L1-RSRP measurements) at the current sub-six (6) GHz than the same measurements at cmWave frequencies.

In current neural network implementations, only a first frequency may (typically) be utilized, where transfer learnings are implemented within the boundaries of the first frequency (f₁). However, current neural network implementations may not consider transfer learning from a first frequency (f₁) to a second frequency (f₂).

Accordingly, in some examples, the systems and methods described herein may be directed to, among other things, implementation of a transfer learning (e.g., frequency transferring) via neural network architecture(s) to obtaining of an optimal beam for a first wave band (e.g., cmWave) based on a neural network trained with data from a second wave band (e.g., sub-six (6) GHz).

The systems and methods described herein may provide various benefits. For example, the systems and methods described may provide improved energy efficiency and reduced network latency by reducing the number of transmissions in a beam sweeping phase in one frequency, and removing the beam sweeping phase completely in another frequency. Furthermore, the systems and methods described may also reduce a number of transmissions in beam flipping, and may, in some situations, remove a need for beam flipping completely.

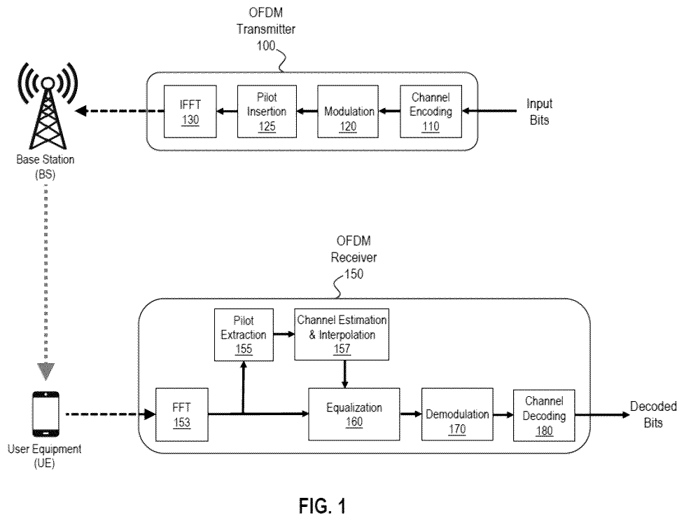

FIG. 1 is a block diagram illustrating a conventional mobile telecommunications transmitter/receiver system, according to examples of the present disclosure. FIG. 1 specifically illustrates a Multiple Input Multiple Output (MIMO) Orthogonal Frequency Division Multiplexing (OFDM) system including both an OFDM transmitter 100, which may be, e.g., a network base station (BS), and an OFDM receiver 150, which may be user equipment (UE), such as, e.g., a cell phone. As would be understood by one of ordinary skill in the art, the OFDM transmitter 100 and OFDM receiver 150 in FIG. 1 may be part of a 3GPP system.

FIG. 1 is provided to illustrate the explanation below, and may omit aspects, features, and/or components not germane to examples of the present disclosure, as would be understood by one of ordinary skill in the art. For example, many more functional blocks may be used in the process of transmitting and receiving OFDM symbols than shown in FIG. 1, as would be understood by one of ordinary skill in the art. Moreover, examples of the present disclosure are in no way limited by FIG. 1, as examples of the present disclosure may apply to apply to non-OFDM systems, as well as one or more input/output channel schemes, such as Multiple Input Single Output (MISO) in addition to, or in lieu of, MIMO.

As shown in FIG. 1, input bits for transmission by the OFDM transmitter 100 are passed through a channel encoding block 110, where, among other things, redundant bits are added for error correction, and then the encoded bits passed through a system modulation block 120. These complex baseband symbols may be represented as an OFDM symbol grid, consisting of N_{T} OFDM symbols and N_{SC} subcarriers. In some examples, pilot signals may be inserted in specific OFDM symbols and subcarriers by pilot insertion block 125, while data is inserted in the remaining OFDM symbols and subcarriers. The OFDM symbol grid created by System Modulation block 120 (and, in some examples, the pilot insertion block 125) is converted from the frequency domain into the time domain by an Inverse Fast Fourier Transform (IFFT) block 130 and then transmitted by the OFDM transmitter 100.

The pilot signals are received via Fast Fourier Transform (IFFT) block 153 and extracted from Y(k) by a pilot extraction block 155, from which a channel estimation & interpolation block 157 estimates the channel and interpolates the OFDM grid, which is provided with the received signal Y(k) in the frequency domain to equalization block 160 which removes detrimental channel impairments and provides the received OFDM grid to a system demodulation block 170, which demodulates the received OFDM grid according to the appropriate modulation scheme and provides the resulting Least Likelihood Ratio (LLR) values to the channel decoding block 180, which uses LLR values to produce the decoded bits.

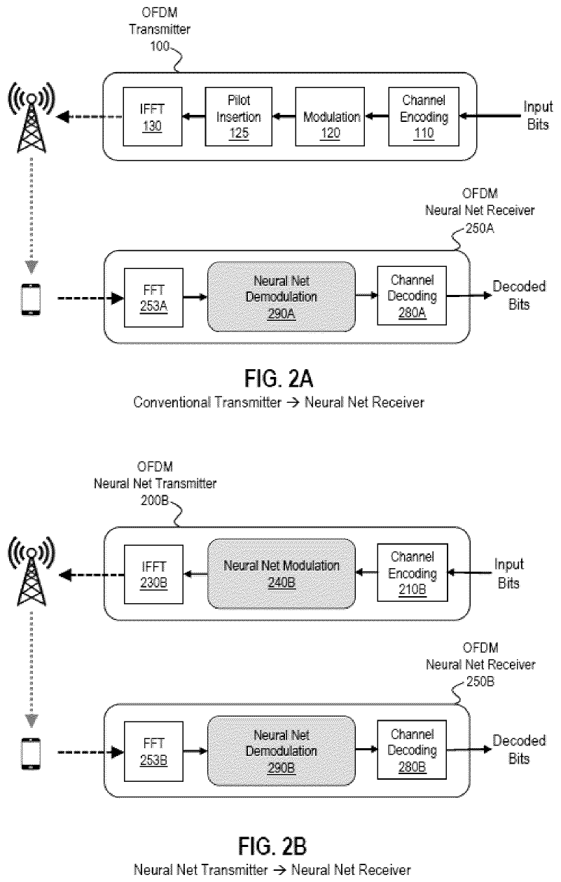

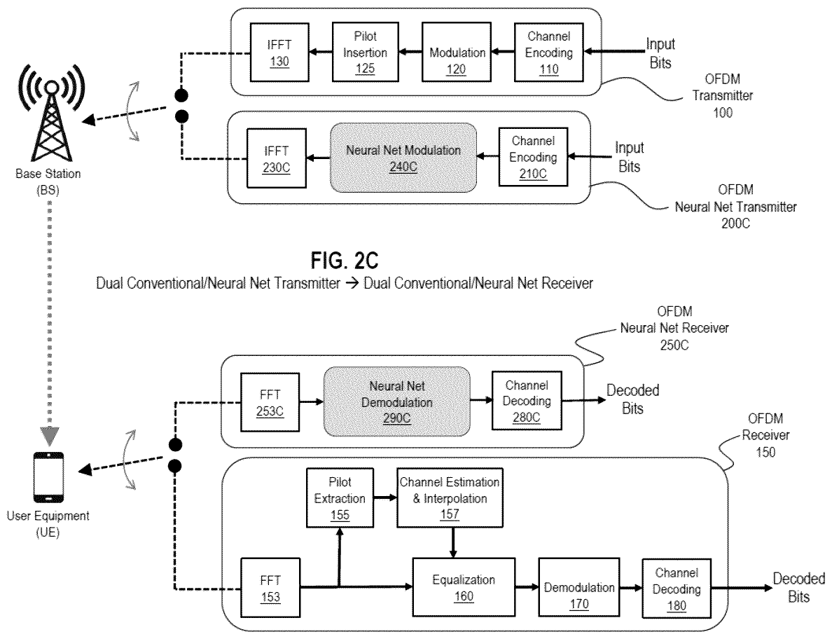

FIGS. 2A-2C are block diagrams illustrating neural net receivers and, in some cases, neural net transmitters in various configurations, according to examples of the present disclosure. FIG. 2A is a block diagram illustrating a conventional OFDM transmitter 100 transmitting to an OFDM neural net receiver 250A. FIG. 2B is a block diagram illustrating an OFDM neural net transmitter 200B transmitting to an OFDM neural net receiver 250B. FIG. 2C is a block diagram illustrating a configuration where both the transmitting side and the receiving side may switch between conventional modulation/demodulation and neural net modulation/demodulation.

FIGS. 2A-2C are provided to illustrate examples of the present disclosure, and may omit aspects, features, and/or components not germane to examples of the present disclosure, as would be understood by one of ordinary skill in the art. As mentioned above, although the present disclosure may often refer to neural network receivers/transmitters in the various examples, it should be understood that the present disclosure applies equally to neuromorphic network receivers/transmitters, as would be understood by one of ordinary skill in the art.

In FIG. 2A, the OFDM transmitter 100 is equivalent to the OFDM transmitter 100 in FIG. 1, but an OFDM neural net receiver 250A replaces the OFDM receiver 150 of FIG. 1. As shown in FIG. 2A, a neural net demodulation system 290A in the OFDM neural net receiver 250A replaces the functionality and operations of the pilot extraction block 155, the channel estimation & interpolation block 157, the equalization block 160, and the system demodulation block 170 of the conventional OFDM receiver 150 in FIG. 1. More specifically, the OFDM neural net receiver 250A receives the OFDM y(n) signal in the time domain and a Fast Fourier Transform (FFT) block 253A converts it into the frequency domain complex OFDM signal Y(k), which is the input for the neural net demodulation system 290A, which produces LLR values as input to a channel decoding block 280A, which uses the LLR values to produce the decoded bits.

The possible implementations of the neural net demodulation system 290 in FIGS. 2A-2C in accordance with examples of the present disclosure are discussed in detail with reference to the drawings further below.

In FIG. 2B, an OFDM neural net transmitter 200B replaces the OFDM transmitter 100 from FIG. 1 and an OFDM neural net receiver 250B replaces the OFDM receiver 150 of FIG. 1. As shown in FIG. 2B, a neural net modulation system 240B in the OFDM neural net transmitter 200B replaces the functionality and operations of the pilot insertion block 125 and the system modulation block 120 of the conventional OFDM transmitter 100 from FIG. 1. In some examples, the OFDM neural net transmitter 200B may not replace the pilot insertion block 125, either because the system is pilotless or because the pilot insertion block 125 remains in place (separate from, and connected to, the neural net modulation system 240B). In such examples, the pilot extraction block 155 or some form thereof may also remain in place on the receiving side (separate from, and connected to, the neural net demodulation system 290B) or may not be needed in a pilotless system.

Returning to FIG. 2B, the OFDM neural net transmitter 200B receives the input bits for transmission, which are passed through a channel encoding block 210B, where, among other things, redundant bits are added for error correction, and then the encoded bits are passed through the neural net modulation system 240B which produces the complex OFDM symbol grid (according to the appropriate modulation scheme), which is then converted from the frequency domain into the time domain by an Inverse Fast Fourier Transform (IFFT) block 230B and transmitted by the OFDM neural net transmitter 200B. Similarly to FIG. 2A, the OFDM neural net receiver 250B receives the OFDM y(n) signal in the time domain and a Fast Fourier Transform (FFT) block 253B converts it into the frequency domain complex OFDM signal Y(k), which is the input for the neural net demodulation system 290A, which produces LLR values as input to a channel decoding block 280B, which uses the LLR values to produce the decoded bits.

Examples according to the present disclosure may transmit and receive OFDM signals with and/or without pilot signals. For example, the conventional OFDM transmitter 100 in FIG. 2A may include the insertion of pilot signals into the OFDM resource grid (by the pilot insertion block 125), but the OFDM neural net receiver 250A replaces the functionality of the pilot extraction block 155 from FIG. 1 with the neural net demodulation system 290A. By contrast, as another example, the transmissions of the OFDM neural net transmitter 200B in FIG. 2B have no pilot signals, i.e., pilotless transmission, which may improve system throughput and efficiency compared to the system in FIG. 2A, where the transmissions have inserted pilot signals.

In FIG. 2C, the transmitting side may switch between the conventional OFDM transmitter 100 and an OFDM neural net transmitter 200C (with channel encoding block 210C, neural net modulation system 240C, and IFFT block 230C), while the receiving side may switch between the conventional OFDM receiver 150 and an OFDM neural net receiver 250C (with FFT block 253C, neural net demodulation system 290C, and channel decoding block 280C).

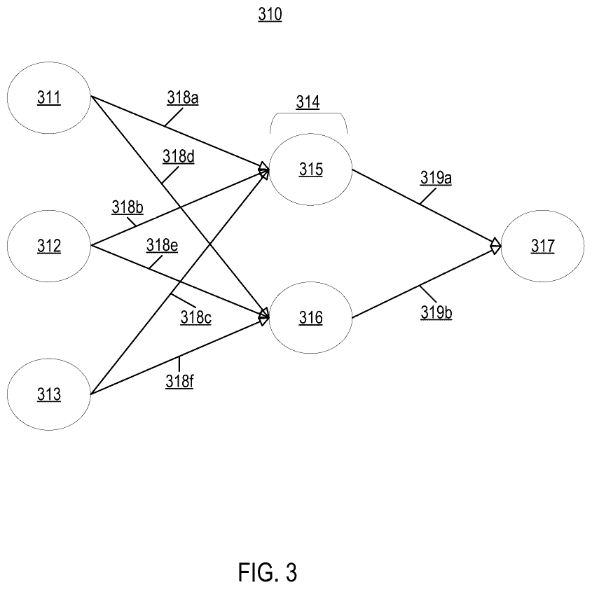

FIG. 3 illustrates a diagram of an implementation structure for a neural net implementing artificial intelligence (AI) and machine learning (ML), according to examples of the present disclosure. In some examples, implementation of neural network 310 (hereinafter also referred to as “network 310”) may include organizing a structure of the network 310 and “training” the network 310. Although an example of a neural network is provided here, it should be appreciated that (as discussed above) other computational methods may be utilized as well.

In some examples, organizing the structure of the network 310 may include network elements including one or more inputs, one or more nodes and an output. In some examples, a structure of the network 310 may be defined to include a plurality of inputs 311, 312, 313, a layer 314 with a plurality of nodes 315, 316, and an output 317.

In addition, in some examples, organizing the structure of the network 310 may include assigning one or more weights associated with the plurality of nodes 315, 316. In some examples, the network 310 may implement a first group of weights 318, including a first weight 318a between the input 311 and the node 315, a second weight 318b between the input 312 and the node 315, a third weight 318c between the input 313 and the node 315. In addition, the network 310 may implement a fourth weight 318d between the input 311 and the node 316, a fifth weight 318e between the input 312 and the node 316, and a sixth weight 318f between the input 313 and the node 16 as well. In addition, a second group of weights 319, including the first weight 319a between the node 315 and the output 317 and the second weight 319b between the node 316 and the output 317 may be implemented as well.

In some examples, “training” the network 310 may include utilization of one or more “training datasets” {(xᵢ, yᵢ)}, where i=1. N for an N number of data pairs. In particular, as will be discussed below, the one or more training datasets {(xᵢ, yᵢ)} may be used to adjust weight values associated with the network 310.

Training of the network 310 may also include, in some examples, may also include implementation of forward propagation and backpropagation. Implementation of forward propagation and backpropagation may include enabling the network 310 to adjust aspects, such as weight values associated with nodes, by looking to past iterations and outputs. In some examples, a forward “sweep” through the network 310 to compute an output for each layer. At this point, in some examples, a difference (i.e., a “loss”) between an output of a final layer and a desired output may be “back-propagated” through previous layers by adjusting weight values associated with the nodes in order to minimize a difference between an estimated output from the network 310 (i.e., an “estimated output”) and an output the network 310 was meant to produce (i.e., a “ground truth”). In some examples, training of the network 310 may require numerous iterations, as the weights may be continually adjusted to minimize a difference between estimated output and an output the network 310 was meant to produce.

In some examples, once weights for the network 310 may be learned, the network 310 may be used make a prediction or “inference”. In some examples, the network 310 may make an inference for a data instance, x*, which may not have been included in the training datasets {(xᵢ, yᵢ)}, to provide an output value y* (i.e., an inference) associated with the data instance x*. Furthermore, in some examples, a prediction loss indicating a predictive quality (i.e., accuracy) of the network 310 may be ascertained by determining a “loss” representing a difference between the estimated output value y* and an associated ground truth value.

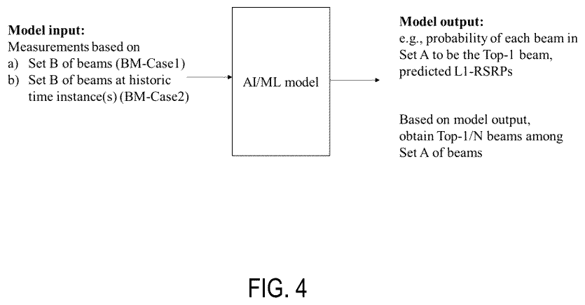

FIG. 4 illustrates a model framework of AI/ML-based BM in a plurality of cases, according to examples of the present disclosure. In particular, FIG. 4 illustrates BM as it pertains to a first case (BM-Case 1) and a second case (BM-Case2). In some examples, BM-Case1 may focus on spatial beam prediction, and BM-Case2 may focuses on temporal beam prediction.

In some examples, the BM techniques may include utilizing a first set of targeted beams that may be predicted by AI/ML techniques (“Set A”), and a second set of beams that may be used for beam sweeping to obtain RSRP measurements (“Set B”). In some examples, Set B can be a subset of or different from Set A. In some examples, Set A and Set B may be determined for both BM-Case 1 and BM-Case2.

In some examples, input(s) to AI/ML-based BM model may include measurements (i.e., data) related to: 1) Set B of beams (BM-Case 1), and 2) Set B of beams at historic time instance(s) (BM-Case 2).

In some examples, output(s) from the AI/ML-based BM model may be, for example, a probability of each beam in Set A may be an optimal beam for transmission (a “Top-1 beam”), which may then be utilized to a top percentile of beams from Set A (“Top-1/N beams”). So, for example and as will be discussed further below, the AI/ML techniques described herein may be implemented to predict an optimal beam and/or a top percentile beam(s) among the beams in Set A using the measurements (e.g., L1-RSRP measurements) obtained from the beams in Set B as inputs.

In some examples, the systems and methods described herein may utilize, for example, channel information a first wave band (e.g., at sub-six (6) GHz) to reduce the overhead of beam sweeping or to increase prediction accuracy at a second (e.g., millimeter wave (mmWave)) wave band. Examples of this channel information may include, but is not limited to CSI, PDP, angle-delay attributes, etc. Specifically, in some instances, information (i.e., data) from the first wave band may be used directly to predict the best beams in the second wave band. Alternatively, in other instances, information from both the first wave band (i.e., a first data set) and the second wave band (i.e., a second wave data set) may be used as the input of neural networks to predict the best beams in the second wave band.

In addition to utilizing information from a first band towards a second band, the systems and methods described may implement transfer learning techniques in machine learning (ML). Generally speaking, transfer learning utilizes the already existing knowledge of a trained neural network in a source domain for something similar or a related task in a target domain. According to examples of the present disclosure, various transfer learning approaches may be used, which may differ based on the number of layers in the base set, the number of layers which are switchable/replaceable, and the training on the target side.

By way of example, and as will be discussed further below, the systems and methods may implement transfer learning to utilize data, knowledge, and insights gained from implementation of a first wave band towards (optimization of) implementation of the second wave band. Moreover, as will be discussed further below, systems and methods described herein may be configured to implement these transfer learning techniques will minimal data requirements. For example, instead of using a totality of CSI information associated with a first wave band towards a second wave band, the systems and methods described may utilize only portions of the CSI information (e.g., from codebook, angle, and/or spatial information) towards the second wave band.

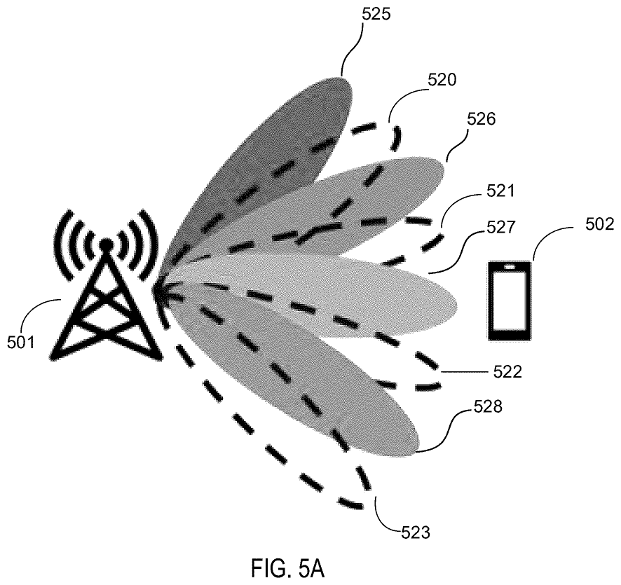

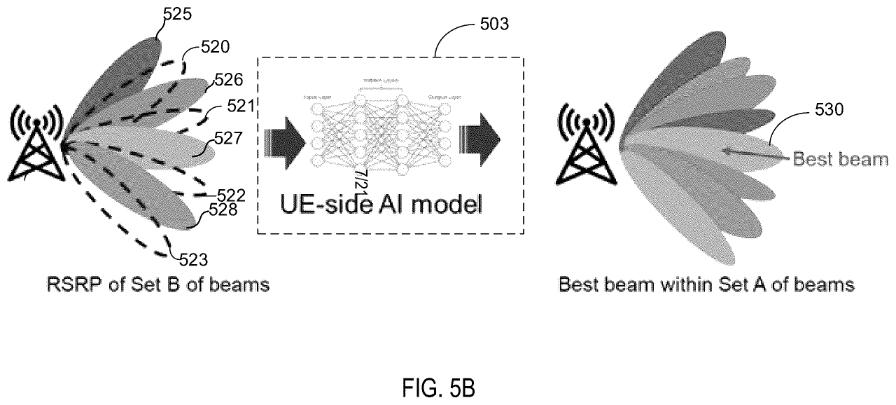

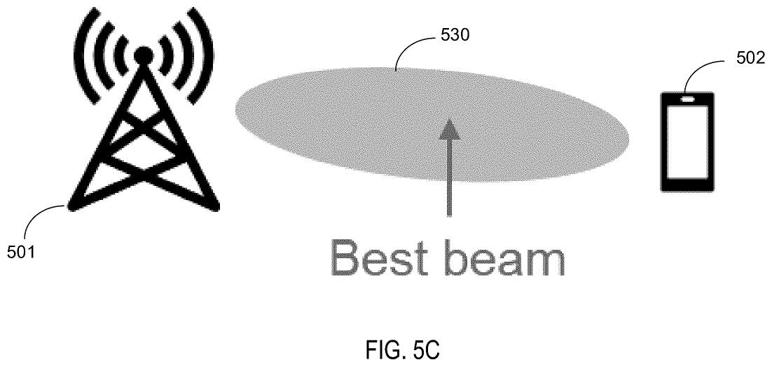

FIGS. 5A-5C illustrate various aspects of an implementation of AI/ML-based BM techniques, according to examples. As discussed above, the AI/ML-based BM techniques implemented by the systems and methods described herein may be deployed at either network (e.g., a gNB) or UE sides.

Initially, as illustrated in FIG. 5A, a base station 501 may conduct beam sweeping, which may include (for example) transmitting signals to UE 502 using beamforming vector taken from a pre-defined codebook. In some examples, a second set of beams 525-528 (i.e., the set of beams filled in) may be a subset of a first set of beams 520-523 (i.e., union of the set of beams filled in and the set of beams in dashed lines). In the beam sweeping stage, only Reference Signal Receive Power (RSPRs) for the second set of beams 525-528 may be measured. In FIG. 5B, a (e.g., pre-trained) AI/ML neural network 503 (similar to that described above) on the UE 502 may calculate the L1-RSRP of all beams in the second set of beams 525-528, and may use the neural network 503 to predict an optimal beam 530. The UE 502 may then feed information associated with the optimal beam 530 (e.g., the beam ID) back to a transmitter (e.g., in the base station 501). In FIG. 5C, the base station 501 may apply the (predicted) optimal beam 530 for transmitting signals to the UE 502.

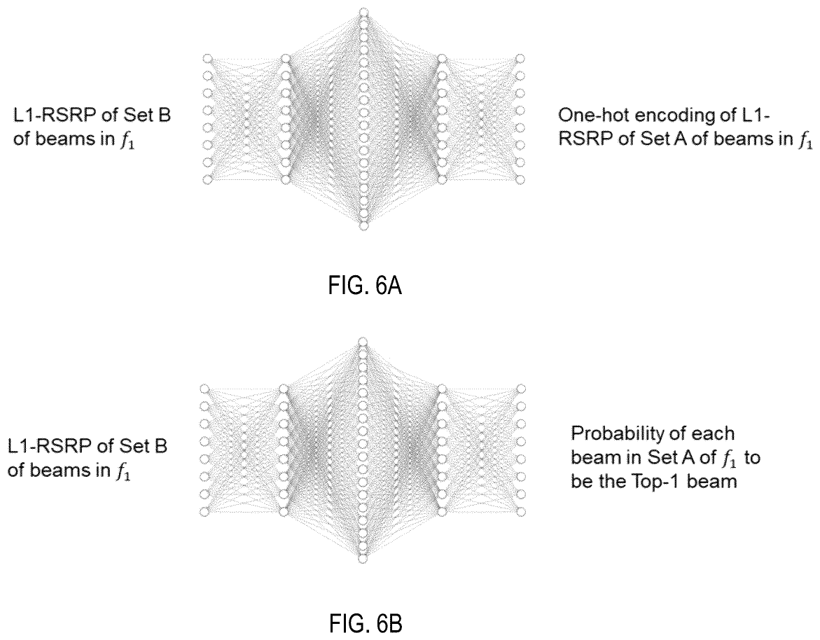

FIGS. 6A-6B illustrate aspects of a neural network architecture that may be utilized for training and testing for BM, according to an example. Specifically, FIG. 6A illustrates a neural network architecture for BM, wherein the inputs of the neural network for BM may be measurements (e.g., L1-RSRP measurements) obtained from a number of transmitted beams for a first frequency (f₁) in a Set B. In some examples, the dimension may be equal to a cardinality of the Set B.

In some examples, an output of the neural network may be one-hot encoded L1-RSRP for the beams in Set A for the first frequency (f₁). As used herein, “one-hot encoding” may implementation of categorical variables (e.g., L1-RSRP) as numerical values in a neural network model. In some examples, a dimension of the output may be equal to the cardinality of a Set A, and an output at the position with the largest (outputted) L1-RSRP may be set to 1, while all other values may be set to 0. In some examples, using a pre-defined loss function, the neural network may be trained using back propagation (as described above).

FIG. 6B illustrates testing of the neural network for BM, which may be performed by setting measurements (e.g., the L1-RSRP measurements) from transmitted beams from Set B for the first frequency (f₁) as input, for which the neural network will output a probability that a beam is the Top-1 (i.e., optimal) beam for each beam in Set A for the first frequency (f₁). Upon comparing the (output) probabilities, predicted Top-K beams may be determined and compared to actual Top-K beams. As used herein, “Top-K beams” may refer to a sampling of tokens with highest probabilities until the specified number of tokens is reached.

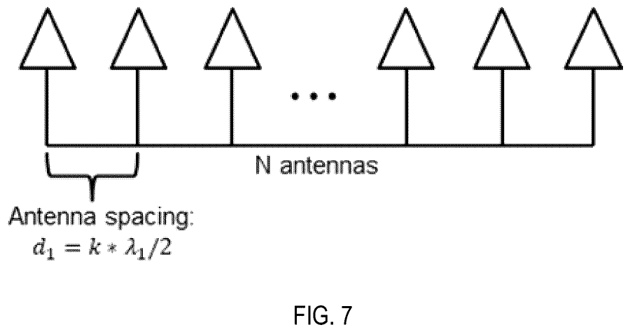

FIG. 7 illustrates a transmitter uniform linear array (ULA) of N antenna items (where N is an integer greater than or equal to one), according to examples of the present disclosure. In some examples, the antennas may be placed with spacing (d₁) according to the following equation:
d₁=k*(λ₁/2)
where λ₁ is the wavelength of a first frequency (f₁) and k is the coefficient to adjust antenna spacing.

As discussed above, systems and methods described herein may implement transfer learning techniques associated with AI and ML to produce a BM framework. In some examples, the BM framework may utilize transfer learning to perform BM at a second frequency (f₂) using a neural network trained at a first frequency (f₁).

In some examples, the model transfer may apply to scenarios where both a numbers of beams in a first set (Set A) and a second set (Set B) for a first frequency (f₁) and a second frequency (f₂) may be same. Also, in some examples, the same codebook may be used for both the first frequency (f₁) and the second frequency (f₂).

In some examples, model transfer may be implemented by systems and methods described herein where various differences may be present as well. For example, in some instances, a number of antenna items in the antenna array can be different. Furthermore, in some instances, the model transfer may also be applied to different types of antenna arrays, such as uniform planar array (UPA) and uniform circular array (UCA). In some examples, the systems and methods described herein may be implemented for different numbers of antenna elements and/or different antenna spacing(s).

In some examples, the systems and methods described herein may implement a model transfer that may require no fine tuning. As used herein, a “no fine tuning” or “without fine tuning” may include transfer of one or more aspects of a first model to the implementation of a second model without any alteration or adjustments to the second model and/or the transferred aspects. In some instances, the transfer without fine tuning may also be referred to as “zero-shot” transferring.

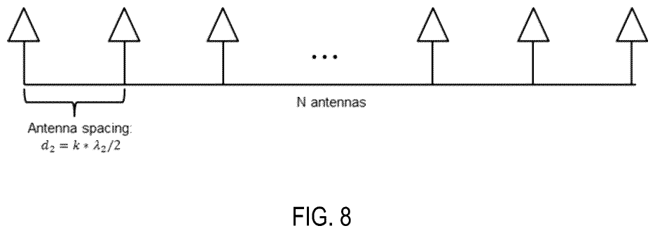

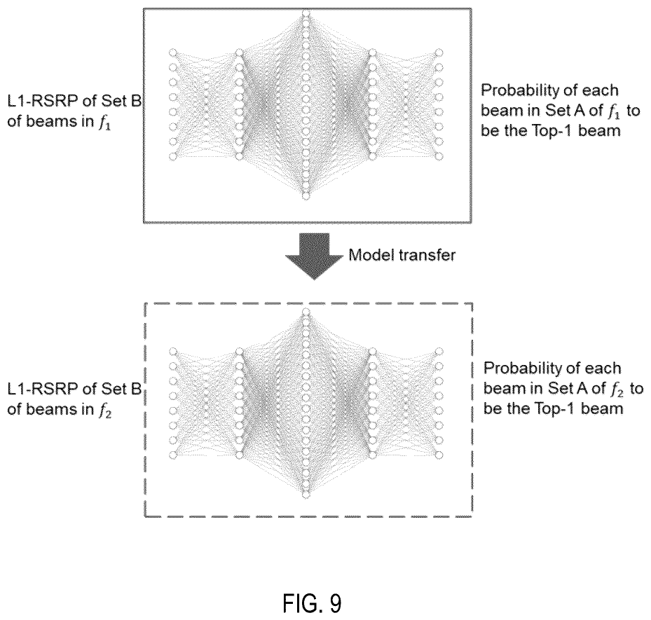

FIG. 8 illustrates an antenna array at a second frequency (f₂) that may have a same number of antenna items and a same antenna-spacing/wavelength ratio as an antenna array at a first frequency (f₁) (e.g., as illustrated in FIG. 7), according to examples of the present disclosure. In some examples, the antennas may be placed with spacing (d₂) according to the following equation:
d₂=k*(λ₂/2)
where λ₂ is the wavelength of a second frequency (f₂) and k is the coefficient to adjust antenna spacing.

In some examples, a zero-shot transfer may be implemented to transfer the neural network trained using measurement (e.g., L1-RSRP measurements) at the first frequency (f₁) for BM implementation at the antenna array utilizing the second frequency (f₂). So, for testing on the antenna array implementing the second frequency (f₂), the measurements (e.g., L1-RSRP measurements) at f₂ may be directly input, so that the neural network can output a probability associated with each beam in Set A of the second frequency (f₂) and predict the best beam ID.

FIG. 9 illustrates aspects of a neural net architecture implementing zero-shot model transfer learning from a first frequency (f₁) to a second frequency (f₂) without fine tuning, according to examples of the present disclosure. So, in some examples, model transfer may be implemented between a first model where measurements (e.g., L1-RSRP measurements) may be input to generate a probability of each beam in Set A of a first frequency (f₁) to be a Top-1 (i.e., optimal) beam, wherein measurements (e.g., L1-RSRP measurements) of Set B of beams at a second frequency (f₂) may be input to generate a probability of each beam in Set A of a second frequency (f₂) to be a Top-1 (i.e., optimal) beam.

So, in some examples, because beam width(s) of the beams used at the first frequency (f₁) and the second frequency (f₂) are similar due to the above-mentioned antenna array properties used at both frequencies, zero-shot transfer learning may be implemented. It may be appreciated that while there may be differences in the CSI (e.g., path loss, delay, etc.), the direction information may be similar. For these reasons, the model trained at the first frequency (f₁) can be directly transferred for use at the second frequency (f₂).

In some examples, the systems and methods described herein may implement a model transfer that may include transfer of one or more aspects of a first model to the implementation of a second model with alteration or adjustments to the second model and/or the transferred aspects. In some instances, this may be referred to as model transfer “with fine tuning.”

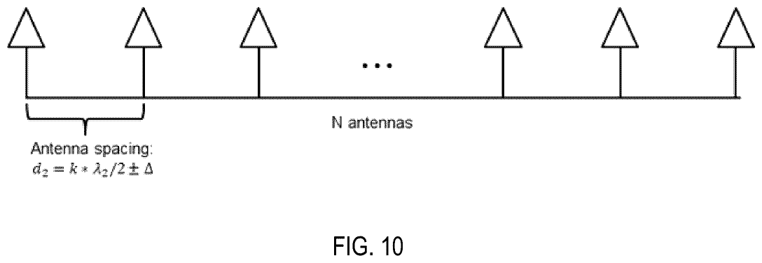

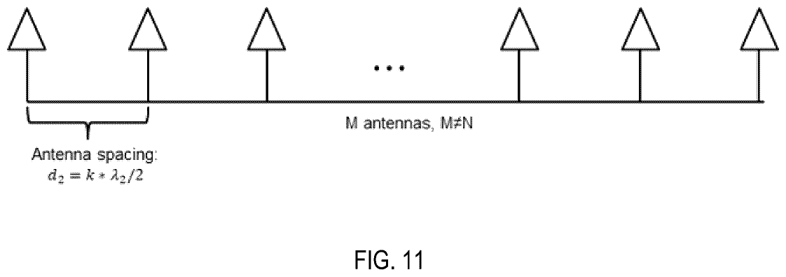

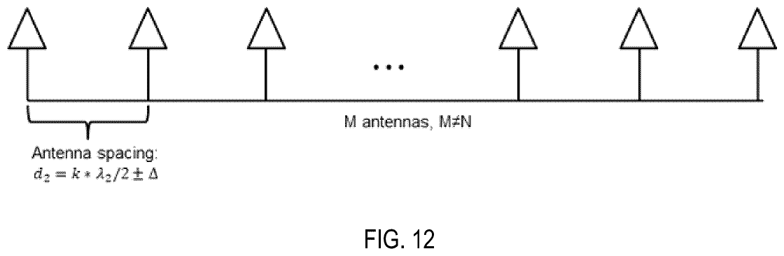

For example, in some examples, and as discussed above, fine tuning in model transferring may be required if a configuration criterion (e.g., an antenna array setup) for f₂ may be different from that for f₁. FIG. 10 illustrates an antenna array setup for a second frequency (f₂) that may have a same number of antennas but may have a different antenna-spacing/wavelength ratio than an antenna array setup for a first frequency (f₁), according to examples of the present disclosure. FIG. 11 illustrates an antenna array setup wherein an antenna array setup for a second frequency (f₂) may have an M number of antennas, and an antenna array setup wherein an antenna array setup for a first frequency (f₁) may have an N number of antennas (i.e., M≠N), but have a same antennas-spacing/wavelength ratio, according to an example. In some examples, the beam width of beams at the second frequency (f₂) may be different from that of beams at the first frequency (f₁). FIG. 12 illustrates an antenna setup for a second frequency (f₂) having different numbers of antennas and different antennas-spacing/wavelength ratio than that for an antenna array setup for a first frequency (f₁), according to an example.

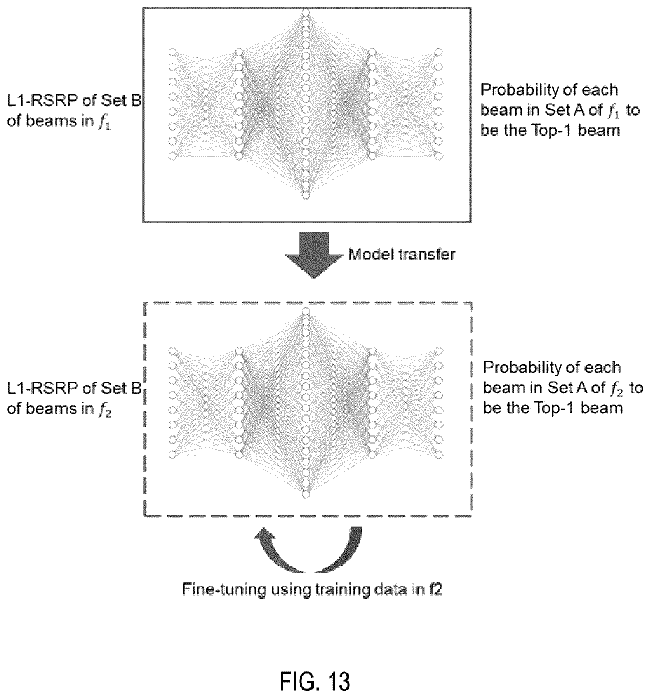

FIG. 13 illustrates a neural network operation implementing data transfer learning where measurements (e.g., L1-RSRP measurements) for a second frequency (f₂) may be used as input for a neural network trained in a first frequency (f₁), according to examples of the present disclosure. Specifically, FIG. 13 illustrates a framework of model transferring with fine tuning for the examples illustrated in FIGS. 10-12.

In some examples, the measurements may be used to predict a beam identifier (ID) for the first frequency (f₁). Specifically, after transferring the neural network trained for a first frequency (f₁) to a second frequency (f₂), (new) training samples obtained for the second frequency (f₂) may be implemented to update weights of the neural network (as described above).

In addition to model transfer learning, data transfer learning may be implemented as well. So, in some examples, an antenna array for a second frequency (f₂) may have a same number of antennas and a same antenna-spacing/wavelength ratio as that of for an antenna array for a first frequency (f₁).

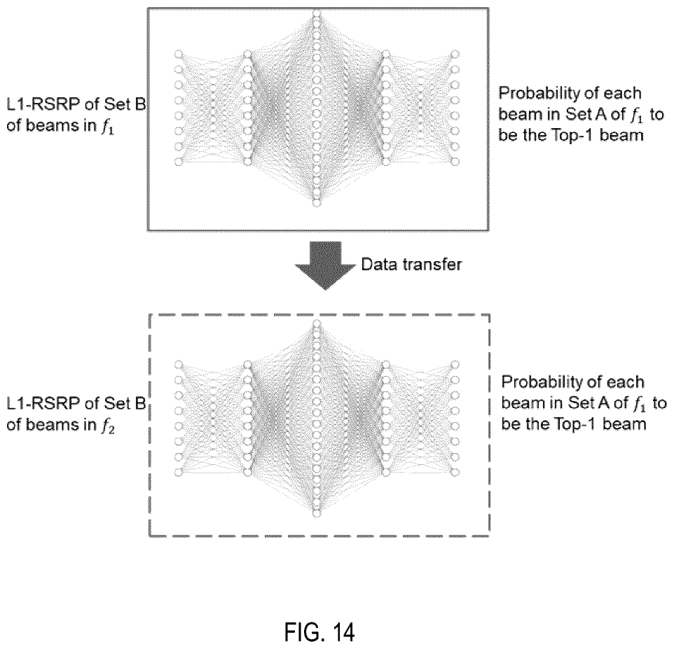

FIG. 14 illustrates data transfer learning where measurements (e.g., L1-RSRP measurements) for a second frequency (f₂) may be used as input of neural network trained in a first frequency (f₁), and may be used to predict a beam ID for the first frequency (f₁), according to an example. So, in some examples, for a first model where Layer 1 reference signal receive power (RSRP) data for a first frequency (f₁) may be input to generate a probability of each beam in Set A of a first frequency (f₁) to be a Top-1 (i.e., optimal) beam, model transfer techniques may be implemented to utilize Layer 1 reference signal receive power (RSRP) of Set B of beams at a second frequency (f₂) to generate a probability of each beam in Set A of a second frequency (f₂) to be a Top-1 (i.e., optimal) beam. That is, during implementation, for a neural network trained using the measurements (e.g., L1-RSRP measurements) at the first frequency (f₁), measurements from beams in Set B at the second frequency (f₂) may be set as the input of the neural network to get the predicted best beam at the first frequency (f₁).

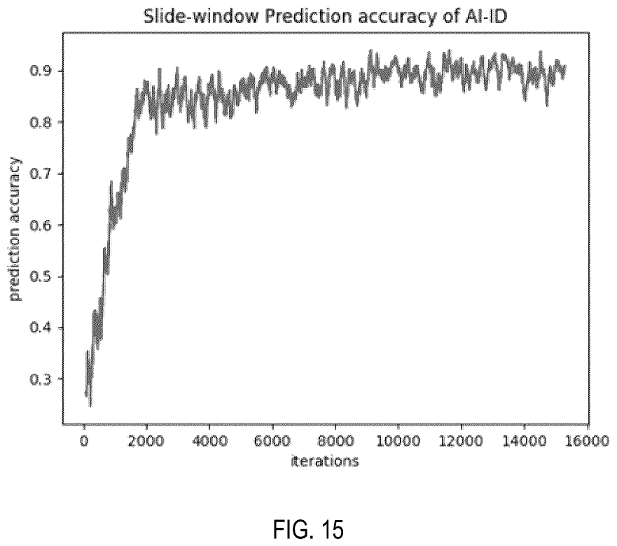

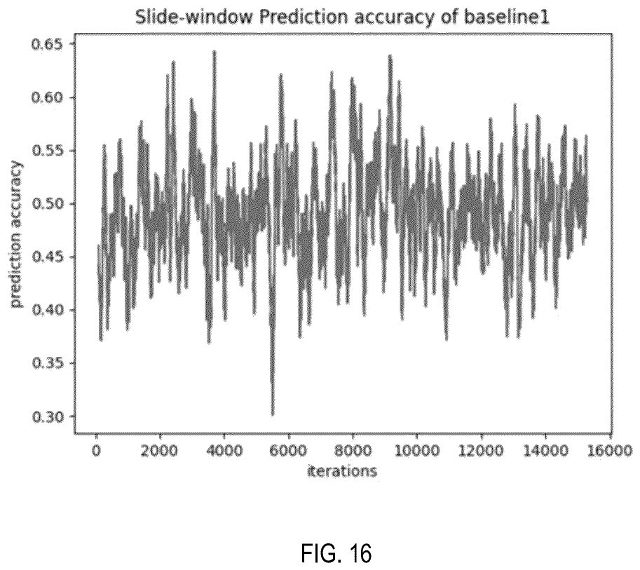

FIGS. 15-16 illustrate charts depicting performance results of an AI base beam management algorithm for prediction accuracy for predicting the best beam ID at a second frequency f₂ (e.g., seven (7) gigahertz (GHz)) for a neural network trained in first frequency f₁ (e.g., three and one-half (3.5) gigahertz (GHz)), according to examples of the present disclosure. For the examples illustrated in FIGS. 15-16, the transmitters at f₂ and f₁ have a same number of antenna items and a same antenna-spacing/wavelength ratio. Accordingly, direct transferring may be applied in these instances. The proposed AI/ML based BM can achieve near ninety percent (90%) prediction accuracy as shown in FIG. 15, while the non-AI/ML baseline can only have near fifty percent (50%) prediction accuracy as shown in FIG. 16.

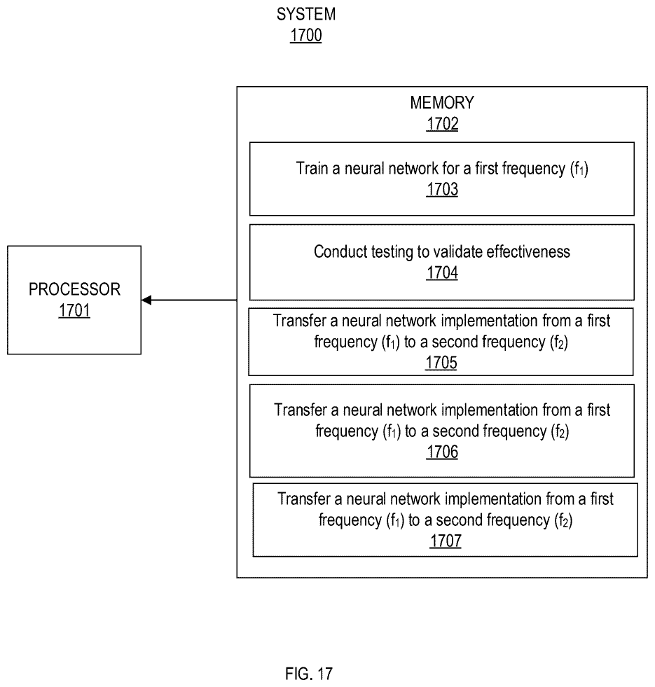

Reference is now made to FIG. 17. FIG. 17 illustrates a block diagram of a system environment, including a system, that may be implemented to use artificial intelligence (AI) techniques to utilize transfer learning (TL)-based method to implement beam management in telecommunications systems, according to an example.

As shown in FIG. 17, the system 1700 may include processor 1701 and the memory 1702. In some examples, the processor 1701 may be configured to execute the machine-readable instructions stored in the memory 1702. It should be appreciated that the processor 1701 may be a semiconductor-based microprocessor, a central processing unit (CPU), an application specific integrated circuit (ASIC), a field-programmable gate array (FPGA), and/or other suitable hardware device.

In some examples, the memory 1702 may have stored thereon machine-readable instructions (which may also be termed computer-readable instructions) that the processor 1701 may execute. The memory 1702 may be an electronic, magnetic, optical, or other physical storage device that contains or stores executable instructions. The memory 1702 may be, for example, random access memory (RAM), an Electrically Erasable Programmable Read-Only Memory (EEPROM), a storage device, an optical disc, or the like. The memory 1702, which may also be referred to as a computer-readable storage medium, may be a non-transitory machine-readable storage medium, where the term “non-transitory”does not encompass transitory propagating signals.

In some examples, the instructions 1703-1707 may implement frequency transfer learning for AI/ML based BM. In some examples, the instructions 1703 may train a neural network for a first frequency (f₁) using measurements from beams in a second set at a first frequency (f₁) as input, and using measurements from beams in a first set at a first frequency (f₁) as a label.

In some examples, the instructions 1704 may conduct testing to validate effectiveness of the trained neural network. Specifically, using measurements of second set of beams for a first frequency (f₁) as input, the trained neural network may output probabilities for each beam in the first set for the first frequency (f₁) to a the Top-1 beam. The instructions 1704 may also obtain a beam identifier (ID) for the best beam ID as well. In some examples, the first frequency (f₁) may be six (6) gigahertz (GHz) or less, and the second frequency (f₂) may be seven (7) to twenty-four (24) gigahertz (GHz).

In some examples, the instructions 1705 may transfer a neural network implementation from a first frequency (f₁) to a second frequency (f₂) under certain network conditions. In some examples, if an antenna array for a second frequency (f₂) may have a same number of antennas items and a same antenna-spacing/wavelength ratio with the first frequency (f₁), the instructions 1705 may enable directly transfer of the neural network trained using measurements (e.g., L1-RSRP measurements) at first frequency (f₁) to a second frequency (f₂) by implementation of “zero-shot” transfer learning, and then setting the measurements (e.g., L1-RSRP measurements) at the second frequency (f₂) as the neural network input to predict a Top-1 (i.e., best) beam for the second frequency (f₂), and determine an associated beam identifier (ID).

In some examples, the instruction 1706 may transfer a neural network implementation from a first frequency (f₁) to a second frequency (f₂) under additional network conditions. In some examples, if an antenna array for a second frequency (f₂) has a different antenna spacing and/or different number of antenna elements, the measurements (e.g., L1-RSRP measurements) for the second frequency (f₂) to may be used to update weights of neural network. Furthermore, the measurements (e.g., L1-RSRP measurements) for the second frequency (f₂) may be set as the neural network input to predict a Top-1 (i.e., best) beam for the second frequency (f₂), and determine an associated beam identifier (ID).

In some examples, the instructions 1707 may transfer a neural network implementation from a first frequency (f₁) to a second frequency (f₂) under still additional network conditions. By way of example, if an antenna array for a second frequency (f₂) may have a same antenna setup as that of the antenna array for a first frequency (f₁), the instructions 107 may implement data transfer to use measurements (e.g., L1-RSRP measurements) from beams in a second set for a second frequency (f₂) as input to the neural network to predict a to predict a Top-1 (i.e., best) beam for the second frequency (f₂), and determine an associated beam identifier (ID).

Additionally, and as described above, although not depicted, instructions 1703-1710 may be configured to utilize various artificial intelligence (AI) and machine learning (ML) based tools. For instance, these artificial intelligence (AI) and machine learning (ML) based tools may be used to generate models that may include a neural network (e.g., a recurrent neural network (RNN)), generative adversarial network (GAN), a tree-based model, a Bayesian network, a support vector, clustering, a kernel method, a spline, a knowledge graph, or an ensemble of one or more of these and other techniques. It should also be appreciated that the system 1700 may provide other types of machine learning (ML) approaches as well, such as reinforcement learning, feature learning, anomaly detection, etc.

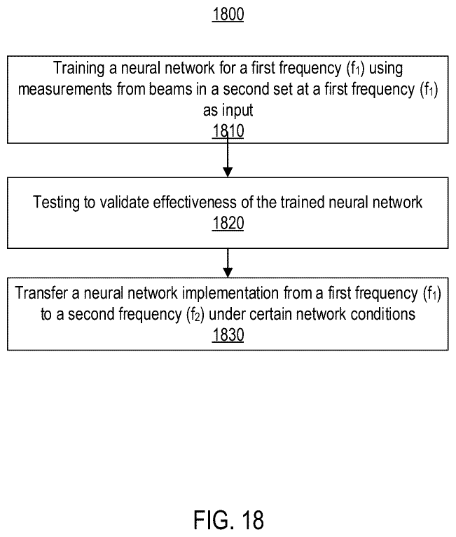

FIG. 18 illustrate a method for utilizing artificial intelligence (AI) and machine learning (ML)-based transfer learning for beam management (BM), according to an example. The method 1800 is provided by way of example, as there may be a variety of ways to carry out the method described herein. Each block shown in FIG. 18 may further represent one or more processes, methods, or subroutines, and one or more of the blocks may include machine-readable instructions stored on a non-transitory computer-readable medium and executed by a processor or other type of processing circuit to perform one or more operations described herein.

Although the method 1800 is primarily described as being performed by system 1700 as shown in FIG. 17, the method 1800 may be executed or otherwise performed by other systems, or a combination of systems. It should be appreciated that, in some examples, the method 1800 may be configured to incorporate artificial intelligence (AI) or deep learning techniques, as described above. It should also be appreciated that, in some examples, the method 1800 may be implemented in conjunction with a content platform (e.g., a social media platform) to generate and deliver content.

Reference is now made with respect to FIG. 18. At 1810, a neural network may be trained for a first frequency (f₁) using measurements from beams in a second set at a first frequency (f₁) as input, and using measurements from beams in a first set at a first frequency (f₁) as a label.

At 1820, testing may be conducted to validate effectiveness of the trained neural network. Specifically, using measurements of second set of beams for a first frequency (f₁) as input, the trained neural network may output probabilities for each beam in the first set for the first frequency (f₁) to a the Top-1 beam. A beam identifier (ID) may also be obtained for the best beam ID as well.

At 1830, a neural network implementation from a first frequency (f₁) to a second frequency (f₂) may be transferred under certain network conditions. In some examples, if an antenna array for a second frequency (f₂) may have a same number of antennas items and a same antenna-spacing/wavelength ratio with the first frequency (f₁), the instructions 105 may enable directly transfer of the neural network trained using measurements (e.g., L1-RSRP measurements) at first frequency (f₁) to a second frequency (f₂) by implementation of “zero-shot” transfer learning, and then setting the measurements (e.g., L1-RSRP measurements) at the second frequency (f₂) as the neural network input to predict a Top-1 (i.e., best) beam for the second frequency (f₂), and determine an associated beam identifier (ID).

In some examples, a neural network implementation from a first frequency (f₁) to a second frequency (f₂) may be transferred under additional network conditions. In some examples, if an antenna array for a second frequency (f₂) has a different antenna spacing and/or different number of antenna elements, measurements (e.g., L1-RSRP measurements) for the second frequency (f₂) to may be used to update weights of neural network. Furthermore, the measurements (e.g., L1-RSRP measurements) for the second frequency (f₂) may be set as the neural network input to predict a Top-1 (i.e., best) beam for the second frequency (f₂), and determine an associated beam identifier (ID).

In some examples, a neural network implementation from a first frequency (f₁) to a second frequency (f₂) may be transferred under still additional network conditions. By way of example, if an antenna array for a second frequency (f₂) may have a same antenna setup as that of the antenna array for a first frequency (f₁), the instructions 107 may implement data transfer to use measurements (e.g., L1-RSRP measurements) from beams in a second set for a second frequency (f₂) as input to the neural network to predict a to predict a Top-1 (i.e., best) beam for the second frequency (f₂), and determine an associated beam identifier (ID).

In some examples, the systems and methods described herein may include a transfer learning (TL)-based method to implement beam management in telecommunications systems, the method comprising: generating a neural network model for beam management in a telecommunications system, designating a plurality of labels for the neural network model, wherein one of the plurality of labels is associated with measurements from beams associated with a first set of measurements for a first frequency, training the neural network model for the first frequency to produce a trained neural network model, including inputting measurements from beams associated with a second set of measurements for the first frequency, implementing the trained neural network model to output a probability of each beam in the first set of measurements for the first frequency is a Top-1 beam, and determining a beam identifier (ID) for the Top-1 beam for the first frequency. In some examples, if an antenna array for second frequency has a same number of antenna items and a same antenna-spacing/wavelength ratio as with the first frequency, the method further comprising directly transferring the trained neural network model trained for the first frequency to a second frequency to implement transfer learning, including inputting measurements associated with the second frequency to predict a Top-1 beam for the second frequency, and the measurements associated with the second frequency include L1-RSRP measurements for the second frequency. In some examples, if an antenna array for a second frequency has different antenna spacing and/or different number of antenna elements than an antenna array for the first frequency, the method further comprising inputting measurements associated with the second frequency to update weights of the trained neural network model, and implementing the trained neural network model with the updated weights to predict a Top-1 beam for the second frequency. In some examples, the measurements associated with the second frequency include L1-RSRP measurements. In some examples, wherein if an antenna array for a second frequency has a same antenna setup as that of the antenna array for the first frequency, the method further comprising inputting measurements for the second frequency to the trained neural network model to predict a Top-1 beam for the first frequency. In some examples, the measurements associated with the second frequency include L1-RSRP measurements, and the first frequency is a frequency that is six (6) gigahertz or less, and wherein a second frequency is a frequency between seven (7) and twenty-four (24) gigahertz. It may be appreciated that, in other examples, other frequencies and frequency combinations may be implemented as well.

In some examples, the systems and methods described herein may include a transfer learning (TL)-based system, comprising at least one processor with a non-transitory computer-readable memory storing instructions executable by the at least one processor to generate a neural network model for beam management in a telecommunications system, designate a plurality of labels for the neural network model, wherein one of the plurality of labels is associated with measurements from beams associated with a first set of measurements for a first frequency, train the neural network model for the first frequency to produce a trained neural network model, including inputting measurements from beams associated with a second set of measurements for the first frequency, implement the trained neural network model to output a probability of each beam in the first set of measurements for the first frequency is a Top-1 beam, and determine a beam identifier (ID) for the Top-1 beam for the first frequency. In some examples, if an antenna array for a second frequency has a same number of antenna items and a same antenna-spacing/wavelength ratio as with the first frequency, the non-transitory computer-readable memory stores instructions executable by the at least one processor to further transfer the trained neural network model trained for the first frequency to a second frequency to implement transfer learning, including inputting measurements associated with the second frequency to predict a Top-1 beam for the second frequency. In some examples, if an antenna array for a second frequency has different antenna spacing and/or different number of antenna elements than an antenna array for the first frequency, the non-transitory computer-readable memory stores instructions executable by the at least one processor to further input measurements associated with the second frequency to update weights of the trained neural network model and implement the trained neural network model with the updated weights to predict a Top-1 beam for the second frequency. In some examples, if an antenna array for a second frequency has a same antenna setup as that of the antenna array for the first frequency, the non-transitory computer-readable memory stores instructions executable by the at least one processor to further input measurements for the second frequency to the trained neural network model input to predict a Top-1 beam for the first frequency. In some examples, the first frequency is a frequency that is six (6) gigahertz or less. It may be appreciated that other frequencies or frequency ranges may be implemented as well.

In some examples, a transfer learning (TL)-based method to implement beam management in telecommunications systems, the method comprising generating a neural network model for beam management in a telecommunications system, designating a plurality of labels for the neural network model, wherein one of the plurality of labels is associated with measurements from beams associated with a first set of measurements for a first frequency, training the neural network model for the first frequency to produce a trained neural network model, including inputting measurements from beams associated with a second set of measurements for the first frequency, implementing the trained neural network model to output a probability of each beam in the first set of measurements for the first frequency is a Top-1 beam for the first frequency, inputting measurements associated with a second frequency to update weights of the trained neural network model, and implementing the trained neural network model with the updated weights to predict a Top-1 beam for the second frequency. In some examples, the measurements associated with the second frequency include L1-RSRP measurements, wherein the first frequency is a frequency that is six (6) gigahertz or less, wherein the second frequency is a frequency greater than six (6) gigahertz and less than twenty-four (24) gigahertz. In some examples, the measurements associated with the first frequency and the measurements associated with the second frequency include channel state information (CSI), power delay profile (PDP), and angle-delay attributed, and further comprising determining a beam identifier (ID) for the Top-1 beam for the first frequency.

While examples described herein are directed to configurations as shown, it should be appreciated that any of the components described or mentioned herein may be altered, changed, replaced, or modified, in size, shape, and numbers, or material, depending on application or use case, and adjusted for desired resolution or optimal measurement results. Moreover, single components may be provided as multiple components, and vice versa, to perform the functions and features described herein. It should be appreciated that the components of the system described herein may operate in partial or full capacity, or it may be removed entirely. It should also be appreciated that analytics and processing techniques described herein with respect to the optical measurements, for example, may also be performed partially or in full by other various components of the overall system.

It should be appreciated that data stores may also be provided to the apparatuses, systems, and methods described herein, and may include volatile and/or nonvolatile data storage that may store data and software or firmware including machine-readable instructions. The software or firmware may include subroutines or applications that perform the functions of the measurement system and/or run one or more application that utilize data from the measurement or other communicatively coupled system.

The various components, circuits, elements, components, and interfaces may be any number of mechanical, electrical, hardware, network, or software components, circuits, elements, and interfaces that serves to facilitate communication, exchange, and analysis data between any number of or combination of equipment, protocol layers, or applications. For example, the components described herein may each include a network or communication interface to communicate with other servers, devices, components or network elements via a network or other communication protocol.

What has been described and illustrated herein are examples of the disclosure along with some variations. The terms, descriptions, and figures used herein are set forth by way of illustration only and are not meant as limitations. Many variations are possible within the scope of the disclosure, which is intended to be defined by the following claims-and their equivalents-in which all terms are meant in their broadest reasonable sense unless otherwise indicated.

1. A transfer learning (TL)-based method to implement beam management in telecommunications systems, the method comprising:
generating a neural network model for beam management in a telecommunications system;
designating a plurality of labels for the neural network model, wherein one of the plurality of labels is associated with measurements from beams associated with a first set of measurements for a first frequency;
training the neural network model for the first frequency to produce a trained neural network model, including inputting measurements from beams associated with a second set of measurements for the first frequency;
implementing the trained neural network model to output a probability of each beam in the first set of measurements for the first frequency is a Top-1 beam; and
determining beam identifiers (IDs) for the Top-K beams for the first frequency.

2. The TL-based method of claim 1, wherein if an antenna array for second frequency has a same number of antenna items and a same antenna-spacing/wavelength ratio as with the first frequency, the method further comprising:
directly transferring the trained neural network model trained for the first frequency to a second frequency to implement transfer learning, including inputting measurements associated with the second frequency to predict a Top-1 beam for the second frequency.

3. The TL-based method of claim 2, wherein the measurements associated with the second frequency include L1-RSRP measurements for the second frequency.

4. The TL-based method of claim 1, wherein if an antenna array for a second frequency has different antenna spacing and/or different number of antenna elements than an antenna array for the first frequency, the method further comprising:
inputting measurements associated with the second frequency to update weights of the trained neural network model; and
implementing the trained neural network model with the updated weights to predict Top-K beams for the second frequency.

5. The TL-based method of claim 4, wherein the measurements associated with the second frequency include L1-RSRP measurements.

6. The TL-based method of claim 1, wherein if an antenna array for a second frequency has a same antenna setup as that of the antenna array for the first frequency, the method further comprising:
inputting measurements for the second frequency to the trained neural network model to predict Top-K beams for the first frequency.

7. The TL-based method of claim 6, wherein the measurements associated with the second frequency include L1-RSRP measurements.

8. The TL-based method of claim 1, wherein the first frequency is a frequency that is six (6) gigahertz or less.

9. The TL-based method of claim 7, wherein a second frequency is a frequency between seven (7) and twenty-four (24) gigahertz.

10. A transfer learning (TL)-based system, comprising:
at least one processor with a non-transitory computer-readable memory storing instructions executable by the at least one processor to:
generate a neural network model for beam management in a telecommunications system;
designate a plurality of labels for the neural network model, wherein one of the plurality of labels is associated with measurements from beams associated with a first set of measurements for a first frequency;
train the neural network model for the first frequency to produce a trained neural network model, including inputting measurements from beams associated with a second set of measurements for the first frequency;
implement the trained neural network model to output a probability of each beam in the first set of measurements for the first frequency is a Top-1 beam; and
determine beam identifiers (IDs) for the Top-K beams for the first frequency.

11. The TL-based system of claim 10, wherein if an antenna array for a second frequency has a same number of antenna items and a same antenna-spacing/wavelength ratio as with the first frequency, the non-transitory computer-readable memory stores instructions executable by the at least one processor to further:
transfer the trained neural network model trained for the first frequency to a second frequency to implement transfer learning, including inputting measurements associated with the second frequency to predict Top-K beams for the second frequency.

12. The TL-based system of claim 10, wherein if an antenna array for a second frequency has different antenna spacing and/or different number of antenna elements than an antenna array for the first frequency, the non-transitory computer-readable memory stores instructions executable by the at least one processor to further:
input measurements associated with the second frequency to update weights of the trained neural network model; and
implement the trained neural network model with the updated weights to predict Top-K beams for the second frequency.

13. The TL-based system of claim 10, wherein if an antenna array for a second frequency has a same antenna setup as that of the antenna array for the first frequency, the non-transitory computer-readable memory stores instructions executable by the at least one processor to further:
input measurements for the second frequency to the trained neural network model input to predict Top-K beams for the first frequency.

14. The TL-based system of claim 10, wherein the first frequency is a frequency that is six (6) gigahertz or less.

15. A transfer learning (TL)-based method to implement beam management in telecommunications systems, the method comprising:
generating a neural network model for beam management in a telecommunications system;
designating a plurality of labels for the neural network model, wherein one of the plurality of labels is associated with measurements from beams associated with a first set of measurements for a first frequency;
training the neural network model for the first frequency to produce a trained neural network model, including inputting measurements from beams associated with a second set of measurements for the first frequency;
implementing the trained neural network model to output a probability of each beam in the first set of measurements for the first frequency is a Top-1 beam for the first frequency;
inputting measurements associated with a second frequency to update weights of the trained neural network model; and
implementing the trained neural network model with the updated weights to predict Top-K beams for the second frequency.

16. The TL-based method of claim 15, wherein the measurements associated with the first frequency include L1-RSRP measurements.

17. The TL-based method of claim 15, wherein the first frequency is a frequency that is six (6) gigahertz or less.

18. The TL-based method of claim 15, wherein the second frequency is a frequency greater than six (6) gigahertz and less than twenty-four (24) gigahertz.

19. The TL-based method of claim 15, wherein the measurements associated with the second frequency include L1-RSRP measurements.

20. The TL-based method of claim 15, further comprising determining beam identifiers (IDs) for the Top-K beams for the first frequency.
